(19) United States
(12) Patent Application Publication
(10) Pub. No.: US 2025/0323287 A1
(43) Pub. Date: Oct. 16, 2025

(54) FUEL CELL STACKS AND ASSEMBLIES WITH INSULATION ASSEMBLIES

(71) Applicant: Toyota Motor Engineering & Manufacturing North America, Inc., Plano, TX (US)

(72) Inventors: Utsav Raj Aryal, Ypsilanti, MI (US); Gaohua Zhu, Ann Arbor, MI (US); Charles Alexander Roberts, Farmington Hills, MI (US); Debasish Banerjee, Ann Arbor, MI (US); Yuqing Zhou, Ann Arbor, MI (US); Ercan Mehmet Dede, Ann Arbor, MI (US); Paul Donald Schmalenberg, Ann Arbor, MI (US); Tenghua Shieh, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/635,117

(22) Filed: Apr. 15, 2024

(51) Int. Cl. H01M 8/04007; H01M 8/04029; H01M 8/12; H01M 8/2432

(52) U.S. Cl. CPC H01M 8/04067; H01M 8/04029; H01M 8/12; H01M 8/2432; H01M 2008/1293

(57) ABSTRACT

Fuel cell stacks and fuel cell stack assemblies described herein include an insulation assembly on the longitudinal edges of the set of fuel cells contained therein. In one embodiment, a fuel cell stack includes a set of fuel cells positioned between a pair of end plates. The fuel cell stack also includes a pair of insulation assemblies positioned along opposite side surfaces of the set of fuel cells. The pair of insulation assemblies span a length of the set of fuel cells between the pair of end plates. An insulation assembly includes 1) a cooling plate extending across the set of fuel cells and 2) an insulating layer between the cooling plate and the set of fuel cells.

### TECHNICAL FIELD

The subject matter described herein relates, in general, to fuel cell stacks and, more particularly, to reduced height fuel cell stack assemblies with interspersed insulation assemblies.

### BACKGROUND

Electric vehicles are powered by an electric motor instead of a gas-based internal combustion engine. Hybrid vehicles rely on an electric motor and an internal combustion engine for propulsion. Electric and hybrid vehicles are more environmentally friendly as they produce fewer tailpipe emissions, and in the case of electric vehicles, do not produce any tailpipe emissions. In some examples, an electric motor of a hybrid or electric vehicle is powered by a fuel cell. A fuel cell works like a battery but does not discharge over time and does not need to be recharged. A fuel cell generates electricity via a chemical reaction. A fuel cell generally includes an anode and a cathode positioned on either side of an electrolyte. Fuel such as hydrogen that is stored in a tank of the vehicle is passed to the anode and air is passed to the cathode. One specific type of fuel cell is a proton exchange membrane (PEM), or polymer electrolyte, fuel cell. A PEM fuel cell includes a catalyst that triggers an electrochemical reaction that separates the hydrogen atoms into protons and electrons. The protons and electrons take different paths to the cathode. The electrons pass through a circuit, creating a flow of electricity to power components of the electric vehicle. The protons pass through the electrolyte to the cathode. At the cathode, the protons combine with the oxygen and electrons to produce water and heat as byproducts of the electricity generation process.

### SUMMARY

In one embodiment, example fuel cell stacks and fuel cell stacks include interspersed insulation assemblies that maintain a desired temperature gradient across the fuel cells of the fuel cell stack such that the fuel cells are operated in a target temperature range that enhances power generation efficiency.

In one example, a fuel cell stack includes a set of fuel cells positioned between a pair of end plates. The fuel cell stack also includes a pair of insulation assemblies positioned along opposite side surfaces of the set of fuel cells. The insulation assemblies span the length of the set of fuel cells between the pair of end plates. The insulation assemblies include 1) a cooling plate extending across the set of fuel cells and 2) an insulating layer between the cooling plate and the set of fuel cells.

In one embodiment, a fuel cell stack assembly is described. The fuel cell stack assembly includes a set of fuel cell stacks adjacent to one another. Each fuel cell stack includes a set of fuel cells positioned between a pair of end plates. The fuel cell stack assembly also includes a pair of insulation assemblies per fuel cell stack. The insulation assemblies are positioned along opposite side surfaces of a respective set of fuel cells of a fuel cell stack and span a length of the respective set of fuel cells between the pair of end plates. An insulation assembly includes 1) a cooling plate extending across the respective set of fuel cells and 2) an insulating layer between the cooling plate and the respective set of fuel cells.

In one embodiment, a fuel cell stack assembly is disclosed. The fuel cell stack assembly includes a set of high-temperature proton exchange membrane (PEM) fuel cell stacks adjacent to one another. Each PEM fuel cell stack includes a set of fuel cells positioned between a pair of end plates. Each PEM fuel cell stack also includes a pair of insulation assemblies per fuel cell stack. The insulation assemblies are positioned along opposite side surfaces of a respective set of fuel cells of a PEM fuel cell stack and span a length of the respective set of fuel cells between the pair of end plates. The insulation assembly includes 1) a cooling plate extending across the respective set of fuel cells and 2) an insulating layer between the cooling plate and the respective set of fuel cells.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an electric or hybrid truck within which fuel cell stacks and fuel cell stack assemblies disclosed herein may be implemented.

FIG. 2 is a diagrammatic representation of the fuel cell stack assembly with interspersed insulation assemblies.

FIGS. 3A and 3B are views of a fuel cell stack with a pair of insulation assemblies joined to it.

FIG. 4 is an exploded view of a fuel cell stack assembly with interspersed insulation assemblies.

FIG. 5 is a cross-sectional view of a fuel cell stack with an insulation assembly joined to it.

FIG. 6 depicts a graph of the temperature gradient across a vertical dimension of a fuel cell stack.

FIG. 7 is a cross-sectional view of a fuel cell stack assembly with interspersed insulation assemblies.

FIG. 8 is an exploded view of a per-cell electrically connected fuel cell stack.

### DETAILED DESCRIPTION

Fuel cell stacks and fuel cell stack assemblies exhibiting improved thermal gradients and power efficiency are disclosed herein. As previously described, some electric and hybrid vehicles are powered by fuel cells, which trigger electrochemical reactions that produce electricity from hydrogen and oxygen. Electric and hybrid vehicles may be desirable for their high efficiency and reduced emissions. However, implementing fuel cells in modern electric or hybrid vehicles may be difficult for various reasons. Specifically, fuel cells generate heat as a byproduct of the electrochemical reaction. If a fuel cell is too hot, its performance may drop. As such, fuel cell stacks may include a cooling mechanism to prevent overheating individual fuel cells.

Fuel cells may be classified by their operating temperature, with different classes of fuel cells being cooled differently. For example, low-temperature fuel cells (i.e., those that operate between 80 and 105 degrees Celsius (° C.)) may be cooled per fuel cell. That is, the cooling modality includes a cooling unit per fuel cell of the fuel cell stack. For example, each bipolar plate of a fuel cell may include channels through which a liquid coolant may pass. This per-fuel cell cooling modality increases the complexity, cost, and likelihood of potential failure of the associated low-temperature fuel cell stack. Moreover, the low-temperature fuel cell cooling system may include 1) a radiator and fan to cool the liquid coolant passed to each fuel cell, 2) a humidifier, 3) an intercooler, and 4) a demister. Thus, not only are individual fuel cells complex, but so is the entire fuel cell stack. In certain situations, such as in a high-power vehicle (e.g., a semi-truck), two low-temperature fuel cell stacks may be required to generate sufficient electricity to power the heavy-duty truck and its associated components. With low-temperature fuel cell stacks, a single cooling system may not be able to cool a system that generates enough power for certain classes (e.g., 300 kilowatt (kW)) of heavy-duty electric trucks. That is, a single cooling system may support just a fuel cell stack that generates up to 150 kW of power. In this example, the cooling system may include the aforementioned components (e.g., radiator, humidifier, intercooler, and demister) plus an additional radiator, thus taking up more space in a high-power vehicle and adding to the weight of the high-power vehicle.

Another class of fuel cell, a high-temperature fuel cell, has an operating temperature of between 160-200° C. and can produce between 300-500 kW of power. A cooling system for a high-temperature fuel cell stack may not have the additional components (e.g., humidifier, intercooler, demister, and second radiator) that a low-temperature fuel cell stack cooling system may have, but may present other challenges for cooling. For example, cooling of high-temperature fuel cell stacks may still be at a per-cell level, which increases the complexity and cost of a fuel cell stack and introduces additional points of potential malfunction. Moreover, to maintain the high-temperature fuel cell stack in a target operating range (i.e., between 160-200° C.) where power-generating efficiency is enhanced, the cooling system may pump a coolant with a high boiling point (i.e., between 160-200° C.). Coolants that have such a high boiling point and that also have 1) low freezing points to facilitate cold start applications, 2) high thermal conductivity, 3) low heat exchange surface area, and 4) that are compatible with current cooling systems are difficult to identify and therefore may be infeasible. As such, coolants with lower boiling points (e.g., around 120° C.) may be used to cool high-temperature fuel cell stacks. However, using such a low-temperature coolant may keep the fuel cell stack at a temperature (e.g., around 120° C.) below an ideal operating temperature such that the efficiency of the fuel cell stack is compromised. That is, similar to operating at too high a temperature, a fuel cell stack that operates at too low a temperature also exhibits performance degradation, and a low boiling point coolant may draw the operating temperature of the fuel cell stack below a target temperature range lower boundary.

In another example, a high-temperature fuel cell may include plates along the edges of the set of fuel cells, which plates draw heat away from the fuel cell stack. However, in these systems, it has been found that the center of the fuel cells (as measured from one lateral cooling plate to another) can reach temperatures greater than 400° C., which may be outside of a target operating temperature range for a high-temperature fuel cell stack. That is, some edge-cooled systems may not be capable of dispersing sufficient heat to maintain the fuel cells within the target operating temperature range of 160-200° C. Moreover, those portions of a fuel cell closest to the cooling plate may operate at a temperature nearer the boiling point of the coolant (e.g., 120° C.) and thus below the target operating range of the fuel cell stack.

That is, a fuel cell stack has a target temperature range wherein, if operated, a maximum amount of energy is created. If the temperature is greater than this target temperature range, the membrane electrode assembly (MEA) of the fuel cells may dry out and may ineffectively and inefficiently generate electricity or may not generate electricity at all. If the temperature is too low, the efficiency of the high-temperature fuel cell stack also suffers. In other words, an outside-the-threshold operation of the fuel cell stack degrades its performance in generating electricity.

Accordingly, the cooling system of the present specification maintains more of the high-temperature fuel cell stack within a target operating temperature range. Specifically, the fuel cell stack and fuel cell stack assembly of the present specification provide a simplified and compact cooling system for use in vehicles with heavy power consumption (e.g., 300 kW electric or hybrid trucks).

Specifically, the fuel cell stack includes an insulation assembly that cools a high-temperature fuel cell stack. The disclosed fuel cell stack may cool high-temperature fuel cells (i.e., that operate between 160-200° C.) of heavy-duty (e.g., 300 kW) trucks via a system that 1) has one radiator, 2) eliminates certain components (e.g., humidifier, intercooler, demister) of a cooling system, and 3) maintains a greater portion of each fuel cell in the target temperature range.

Specifically, the fuel cell stack of the present specification has a reduced overall height (e.g., between three to five centimeters (cm)) as compared to the heights of other fuel cells, which may be between 10-15 cm). Multiple fuel cell stacks may be joined together, for example, stacked on top of one another, with an insulation assembly positioned between adjacent fuel cell stacks. The insulation assembly includes a cooling plate positioned between insulating layers. The reduced height ensures the effect of the coolant is felt more evenly across the fuel cell stack such that the fuel cell stack temperature, particularly in a center region between cooling plates, does not rise above the operating temperature range for the fuel cell stack. The insulating layers reduce the thermal conductivity between the cooling plate and the adjacent fuel cell stacks such that each fuel cell stack may be kept at a temperature higher than the boiling point of the cooling plate and coolant liquid. Experimental results indicate that this arrangement exhibits a smaller temperature gradient across an individual fuel cell stack. This allows the use of a lower-temperature coolant (e.g., 120° C.).

In this way, the disclosed fuel cell stacks and fuel cell stack assemblies with interspersed insulation assemblies enable a more efficient and simple cooling system for high-temperature fuel cell stacks while providing sufficient electricity to power heavy-duty electric vehicles such as trucks. The present fuel cell stack assembly has a reduced cost, weight, and complexity for high power (e.g., 300 kW) applications, has a reduced temperature gradient across the MEA of the fuel cells, and can provide a 130% increase in net fuel cell power.

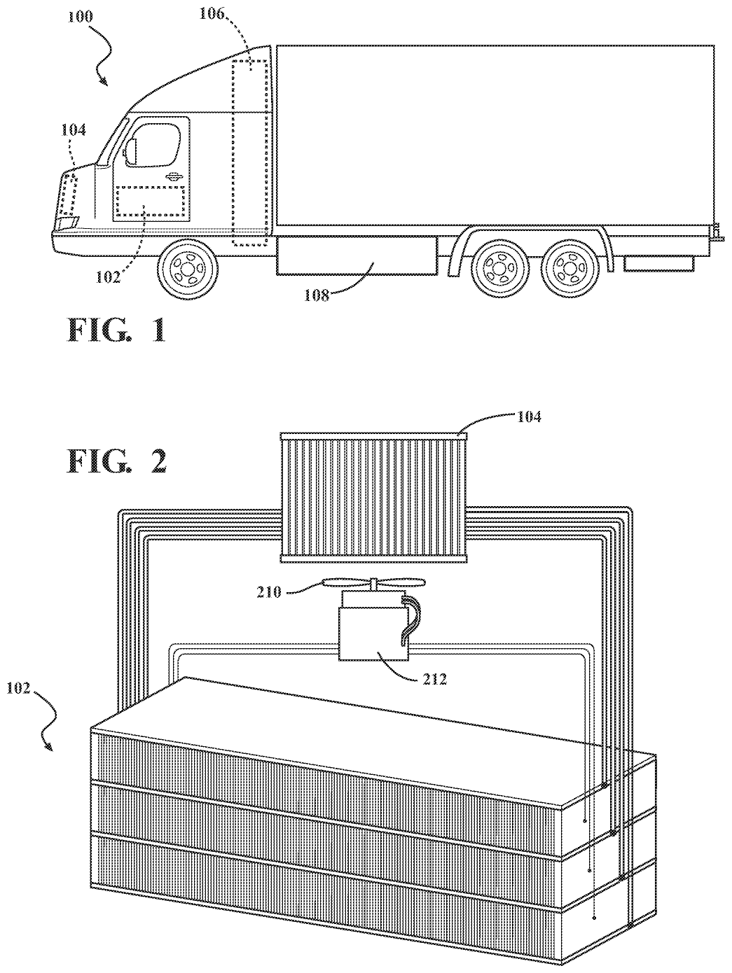

Turning now to the figures, FIG. 1 illustrates one embodiment of a truck 100 within which fuel cell stack assemblies 102 disclosed herein may be implemented. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the truck 100 includes fuel cell stack assemblies 102 that exhibit improved thermal gradients and electricity-generating efficiency. Note that while FIG. 1 depicts the use of the fuel cell stack assemblies 102 on an electric or hybrid truck 100, the fuel cell stack assemblies 102 may be used on other types of electric or hybrid vehicles, automobiles, or any robotic device or a form of transport that, for example, is powered by high-temperature fuel cells and thus benefits from the functionality discussed herein associated with enhanced electricity generation.

In some instances, the truck 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the truck 100 as manipulated by a user (e.g., human driver). In one or more arrangements, the truck 100 can be a manually-controlled vehicle that is configured to operate in only the manual mode.

In one or more arrangements, the truck 100 implements some level of automation in order to operate autonomously or semi-autonomously. As used herein, automated control of the truck 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the truck 100 along a travel route via a computing system to control the truck 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the truck 100. Furthermore, the truck 100 includes, in various arrangements, one or more vehicle systems. For example, the truck 100 includes a propulsion system, a braking system, a steering system, a throttle system, a transmission system, a signaling system, and a navigation system.

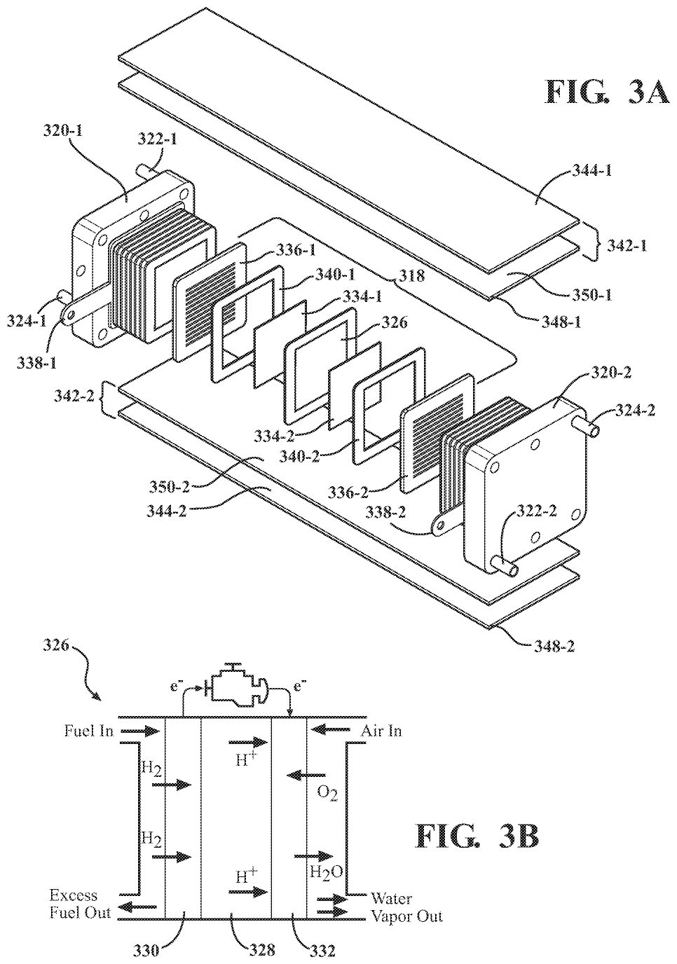

As described above, a fuel-cell powered electric or hybrid truck 100 includes a fuel cell stack assembly 102 that includes a set of fuel cell stacks, an example of which is depicted below in FIG. 3. The fuel cell stacks provide power to electrical components of the truck 100 such as an electric motor that drives the wheels of the truck 100.

In an example, the fuel cell stacks are a set of high-temperature proton exchange membrane (PEM) fuel cell stacks. PEM fuel cell stacks have high power density and may have a lower weight and volume than other types of fuel cells. As described above, fuel cells generate electrical power via an electrochemical reaction. Specifically, fuel cells include an anode and a cathode around a membrane electrode assembly (MEA). Fuel is passed to the anode, and the air is passed to the cathode. An electrochemical reaction between the fuel, oxygen, and catalyst of the MEA generates a flow of electricity with water vapor generated as a byproduct. A PEM fuel cell includes 1) a solid polymer as the electrolyte in the MEA and 2) porous carbon electrodes with platinum, or a platinum alloy, catalysts. Additional details regarding a PEM fuel cell operation are described below in connection with FIGS. 3A and 3B. Note that while a description is provided of a particular type (e.g., PEM fuel cell), the fuel cell stack assembly 102 may include other types of fuel cells such as direct methanol fuel cells, alkaline fuel cells, phosphoric acid fuel cells, molten carbonate fuel cells, solid oxide fuel cells, and reversible fuel cells.

As PEM fuel cells generate electricity from hydrogen, a truck 100 with a PEM fuel cell stack assembly 102 may include an onboard hydrogen tank 106. The hydrogen tank 106 may be in fluid communication with the fluid cell stack assembly 102 via tubes or hoses. Oxygen for the electrochemical reaction is drawn from the surrounding environment of the truck 100 or another vehicle. Note that while the hydrogen tank 106 and fuel cell stack assembly 102 are depicted at particular locations on the truck 100, the hydrogen tank 106 and fuel cell stack assembly 102 may be found at other locations on the truck 100.

As described above, the electrochemical operations of the fuel cell stack assembly 102 may generate heat as a byproduct. As such, the fuel cell stack assembly 102 is cooled via a cooling system, as depicted below in FIG. 2. In general, coolant that has absorbed heat from the fuel cell stack assembly 102 is passed to a radiator 104 that draws heat away from the coolant. As depicted in FIG. 2, the cooling system may include a fan to draw heat away from the heated coolant. The cooled coolant is then transferred to the fuel cell stack assembly 102 for further cooling cycles.

While a fuel cell stack assembly 102 may primarily provide power to the truck 100, in some examples, the truck 100 may include a battery 108 as part of the power system. The battery 108 may provide power to the truck 100 upon startup and may provide power to specific vehicle components such as the headlights, windshield, radio, and alarm system when the truck 100 is turned off. Moreover, to optimize fuel efficiency in a hybrid truck, the fuel cell stack assembly 102 may not respond immediately to increased or decreased power requests. In this example, the battery 108 may provide immediate power to fulfill such requests. Moreover, in an example, the battery 108 may store excess electricity generated by the fuel cell stack assembly 102.

As described above, the fuel cell stack assembly 102 of the present specification may generate power for various vehicles, including heavy-duty trucks 100. Specifically, the fuel cell stack assembly 102 may generate between 200 and 500 kW of power for a heavy-duty electric or hybrid truck 100.

FIG. 2 is a diagrammatic representation of the fuel cell stack assembly 102 with interspersed insulation assemblies. As described above, the fuel cell stack assembly 102 may be formed of multiple high-temperature fuel cell stacks joined to one another. A high-temperature fuel cell stack may be a fuel cell stack that operates in a temperature range of between 160 and 200° C.

The fuel cell stack assembly 102 may be used to power various electrical components of the truck 100. For example, the fuel cell stack assembly 102 may provide power to the electric motor that drives the wheels of the truck 100. As depicted in FIG. 2, this electric motor, or another electric motor 212, may also power a fan 210 of the cooling system. That is, as the fuel cell stack assembly 102 generates electricity through an electrochemical reaction between hydrogen and an anode, the fuel cell stack assembly 102 may heat up. To prevent overheating, a coolant is pumped through insulation assemblies on either side of fuel cell stacks of the fuel cell stack assembly 102. The coolant draws heat from the set of fuel cell stacks. Coolant that has drawn heat from the fuel cell stacks is pumped through hoses or tubes to the radiator 104, where a fan 210 and other physical features (such as fins) of the radiator 104 draw the heat away from the heated coolant. The now-cooled coolant is again cycled by the fuel cell stack assembly 102 to further cool the heat-generating electricity-producing fuel cell stack assembly 102.

In this example, the electricity generated as electrons are separated in the electrochemical reaction is used to power the electric motor 212, which drives the fan 210 to cool the coolant. As such, the cooling system may be closed and does not rely on supplemental or external power sources to cool the fuel cell stack assembly 102.

FIGS. 3A and 3B are views of a fuel cell stack 314 with insulation assemblies 342 on either side. Specifically, FIG. 3A is an exploded view of a fuel cell stack 314 with insulation assemblies 342, while FIG. 3B is a cross-sectional view of an MEA 326 of an individual fuel cell 318. The fuel cell stack 314 includes multiple components that facilitate electrical power generation through an electrochemical reaction between hydrogen, oxygen, and a catalyst. As described above, the fuel cell stack 314 may be of various types, including a proton exchange membrane (PEM), or polymer electrolyte membrane, fuel cell. A PEM fuel cell includes a solid polymer electrolyte and porous carbon electrodes that contain a platinum or platinum alloy catalyst. PEM fuels receive hydrogen from an on-vehicle hydrogen tank 106, and oxygen is drawn towards the fuel cells 318 from an environmental air intake on the truck 100. The hydrogen and oxygen react with the catalyst to form electricity that powers the electric or hybrid truck 100 components. Water vapor is generated as waste during this process.

Each component of the fuel cell stack 314 will be described in turn. The fuel cell stack includes a set of fuel cells 318 arranged next to one another between a pair of end plates 320-1 and 320-2. The end plates 320-1 and 320-2 provide structure and mechanical stability to the fuel cell stack 314. In an example, the end plates 320-1 and 320-2 may be formed of a rigid material such as aluminum or other material.

The end plates 320-1 and 320-2 may also include the inlets 322-1 and 322-2 for the hydrogen and air that are the reactants in the electrochemical reaction and outlet channels 324-1 and 324-2 that expel the exhaust water vapor generated during the electrochemical reaction. Specifically, air and hydrogen are introduced into the inlets 322-1 and 322-2 and distributed to channels in the fuel cells 318 that align with respective inlets 322-1 and 322-2. Similarly, exhaust water vapor is collected through fuel cell outlet channels that align with the outlet channels 324-1 and 324-2 of the end plates 320-1 and 320-2. It may be the case that a majority of the water vapor exits through one outlet channel (e.g., the second outlet channel 324-2) as the generation through electrochemical reaction occurs at the cathode 332 of the MEA 326. However, some diffusion may occur towards the other outlet channel (e.g., the first outlet channel 324-1).

For simplicity and explanation of the operation of a fuel cell 318, one fuel cell 318 of the fuel cell stack 314 is depicted in an exploded fashion in FIG. 3A. The fuel cell 318 includes a membrane electrode assembly (MEA) 326. FIG. 3B depicts a cross-sectional view of the MEA 326. The MEA 326 includes an electrolyte 328 between an anode 330 and a cathode 332. In an example, the electrolyte 328 may be a thin (e.g., 20 microns) membrane formed of a polymer material that is ion permeable but blocks electron flow. The anode 330 and cathode 332 may include platinum particles formed over a carbon support.

As described above, a fuel, such as hydrogen, is passed to the MEA 326 via a first inlet 322-1 while air is fed to the MEA 326 via a second inlet 322-2. Through an electrochemical reaction with the platinum of the anode 330, the hydrogen is separated into hydrogen ions (H⁺) and electrons (e⁻). As depicted in FIG. 3B, the electrons (e⁻) do not permeate through the electrolyte 328 and instead are routed through an external circuit, creating a flow of electricity that is ultimately passed to the electric motor of the truck 100. By comparison, the hydrogen ions (H⁺) permeate through the electrolyte 328. Through an electrochemical reaction with the platinum of the cathode 332, the hydrogen ions (H⁺) combine with the electrons (e⁻) and oxygen in the air to produce water and heat. As this is a high-temperature fuel cell 318 operating at a temperature above the boiling point of water, the water evaporates to form water vapor. The water vapor from the different MEAs 326 is collected and expelled through a network of outlets in the fuel cell stack 314 that align with the outlets 324-1 and 324-2 of the end plates 320-1 and 320-2.

Each fuel cell 318 also includes additional components to aid in the generation of electrical energy from hydrogen, oxygen, and a catalyst. Specifically, each fuel cell 318 may include gas diffusion layers 334-1 and 334-2 on either side of the MEA 326. The gas diffusion layers 334-1 and 334-2 facilitate 1) the transport of the hydrogen and oxygen to the MEA 326 and 2) the removal of water byproducts. In general, the gas diffusion layers 334-1 and 334-2 allow the reactants (i.e., hydrogen and oxygen) in the bipolar plates 336-1 and 336-2 to diffuse to the anode 330 and cathode 332, respectively, of the MEA 326.

Each fuel cell 318 also includes a pair of bipolar plates 336-1 and 336-2 adjacent to and outside the respective gas diffusion layers 334-1 and 334-2. The bipolar plates 336-1 and 336-1 include channels through which reactants (i.e., hydrogen and oxygen) are supplied to the MEA 326. The bipolar plates 336-1 and 336-2 also provide an electrical connection between adjacent fuel cells 318. That is, it may be that each MEA 326 produces a small amount of electricity, for example, less than 1 volt (V), while a component powered by the fuel cell stack 314, such as an electric motor of the truck 100, may require more voltage. As such, as depicted in FIG. 3A, the output of multiple MEAs 326 are combined to generate a desired voltage. Electricity is transmitted from each MEA 326 via respective bipolar plates 336-1 and 336-2. The electricity is ultimately transmitted to current collectors 338-1 and 338-2 and passed to the electric motor of the truck 100. That is, the fuel cell stack 314 further includes a pair of current collectors 338-1 and 338-2 positioned adjacent to opposite end plates 320-1 and 320-2 of the set of fuel cells 318. Each current collector 338-1 and 338-2 is positioned between the set of fuel cells 318 and a respective end plate 320-1 and 320-2.

In an example, each fuel cell 318 may also include a pair of gaskets 340-1 and 340-2 between respective gas diffusion layers 334-1 and 334-2 and bipolar plates 336-1 and 336-2. The gaskets 340-1 and 340-2 provide a gas-tight seal so that the reactants are not lost to the surrounding environment. Lost reactants cannot be used in the electrochemical reaction, thus reducing the efficiency of the fuel cell stack 314 and may pose a risk if allowed to enter the environment.

As described above, the electrochemical process may generate heat in each fuel cell 318. If unchecked, the MEA 326 components (i.e., the anode 330, the electrolyte 328, and the cathode 332) may dry out or otherwise become unable to generate electricity. As such, the fuel cell stack 314 includes a pair of insulation assemblies 342-1 and 342-2, with each insulation assembly 342-1 and 342-2 being positioned along opposite side surfaces of the set of fuel cells 318. While the insulation assemblies 342-1 and 342-2 are depicted as being positioned on a top and bottom surface, respectively, the insulation assemblies 342-1 and 342-2 may be placed on the lateral side surfaces of the fuel cell stack 314, depending on the arrangement of adjacent fuel cell stacks 314.

As depicted in FIG. 3, the insulation assemblies 342-1 and 342-2 span a length of the set of fuel cells 318 between the pair of end plates 320-1 and 320-2 and may also span a width of the set of fuel cells 318. In general, the insulation assemblies 342-1 and 342-2 prevent the fuel cell stack 314 from 1) overheating and 2) falling below a lower boundary of a threshold range. If the fuel cell stack 314 becomes too hot or cold, operational functionality and efficiency may suffer.

To prevent the fuel cell stack 314 from overheating, an insulation assembly 342 includes a cooling plate 344-1 and 344-2 extending across the set of fuel cells 318 longitudinally and laterally, with a longitudianl direction being defined as a direction between the end plates 320-1 and 320-2 of the fuel cell stack 314 and a lateral direction being defined as perpendicular to the longitudinal direction. The cooling plates 344-1 and 344-2 may be formed of a metallic material such as aluminum. Each cooling plate 344-1 and 344-2 may include a coolant inlet 322-1 and a coolant outlet 348-1 and 348-2 that are in fluid communication via an internal coolant channel of the cooling plate 344-1 and 344-2. Coolant is introduced into the cooling plate via an inlet 322-1, where it travels through a channel (e.g., serpentine or otherwise) that is internal to the cooling plate 344. As it travels through the channel, the coolant draws heat from the fuel cells 318. The heated coolant exits the cooling plates 344-1 and 344-2 at a respective outlet 348-1 and 348-2, where it is transported toward the radiator 104 and/or fan 210 for cooling.

In an example, the cooling plates 344-1 and 344-2 transport a water and ethylene glycol-based coolant, which may have a boiling point of 120° C. The water-to-ethylene glycol ratio in the coolant may vary based on application. For example, the coolant may include 30% water and 70% ethylene glycol. In any case, the coolant prevents the operating temperature of the fuel cell stack 314 from rising above an upper boundary of a target temperature range (160-200° C.) as may occur were a higher boiling point temperature coolant used.

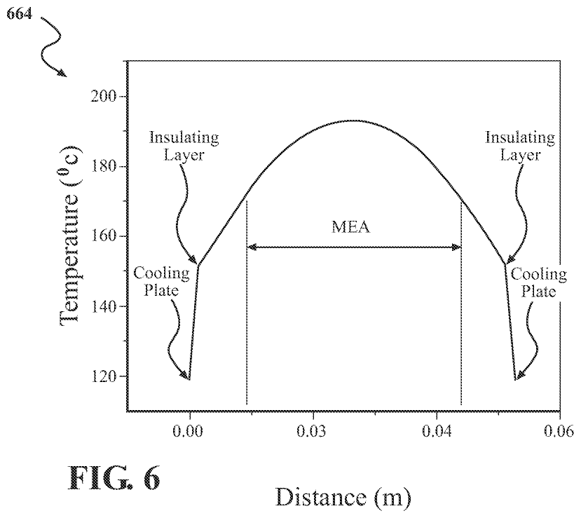

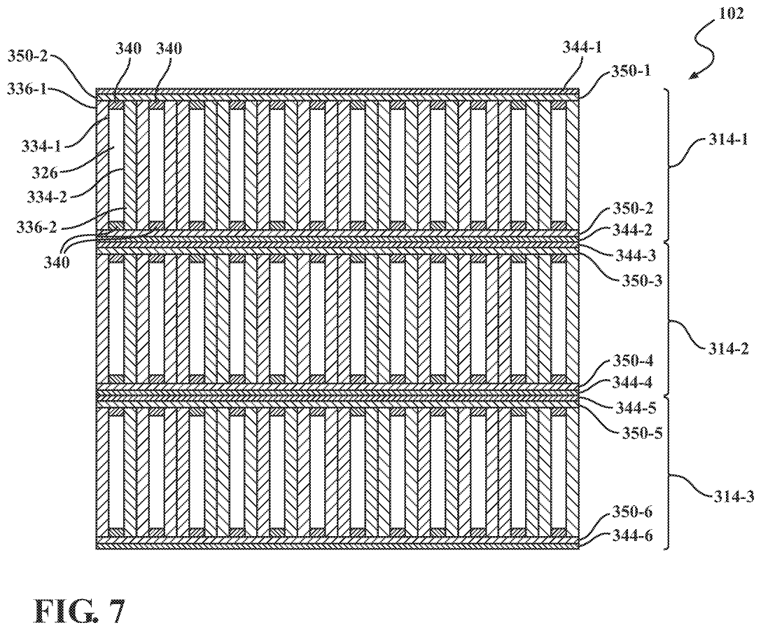

However, as described above, if the temperature of the fuel cell stack 314 is too low, performance is also degraded. Accordingly, to ensure the operating temperature of the fuel cell stack 314 does not fall to the boiling temperature of the coolant (e.g., 120° C.) and stays within the target temperature range (160-200° C.), each insulation assembly 342-1 and 342-2 also includes an insulating layer 350-1 and 350-2 between the respective cooling plate 344-1 and 344-2 and the set of fuel cells 318. As depicted below in FIG. 6, the insulating layer 350-1 and 350-2 acts as a control on the thermal conductivity between the cooling plate 344-1 and 344-2 and the set of fuel cells 318, such that the set of fuel cells 318 do not fall to the temperature of the cooling plate 344-1 and 344-2, which is 120° C. in the example of a water and ethylene glycol-based coolant having a boiling temperature of 120° C.

The insulating layer 350-1 and 350-2 may take a variety of forms. In one example, the insulating layer 350-1 and 350-2 is an insulating adhesive that joins the cooling plate 344-1 and 344-2 to the set of fuel cells 318. For example, the insulating adhesive may be a thermally conductive aluminum or ceramic-based epoxy. Thus, the insulating layer 350-1 and 350-2 joins the cooling plate 344-1 and 344-2 to the fuel cell stack 314 while providing a thermal barrier between the cooling plate 344-1 and 344-2 and the fuel cells 318. In an example, the cooling plate is a single-phase cooling plate. That is, the coolant does not change phase during the cooling operation. As such, the fuel cell stack 314 as depicted herein, maintains a high-temperature PEM fuel cell stack 314 in a desired temperature range, preventing it from falling below or rising above the boundaries of the target range. The present system facilitates the usage of a low-boiling point coolant (e.g., 120° C. boiling point) with a low freezing point to facilitate cold start applications, a high thermal conductivity, a low heat exchange surface area, and that is compatible with existing systems.

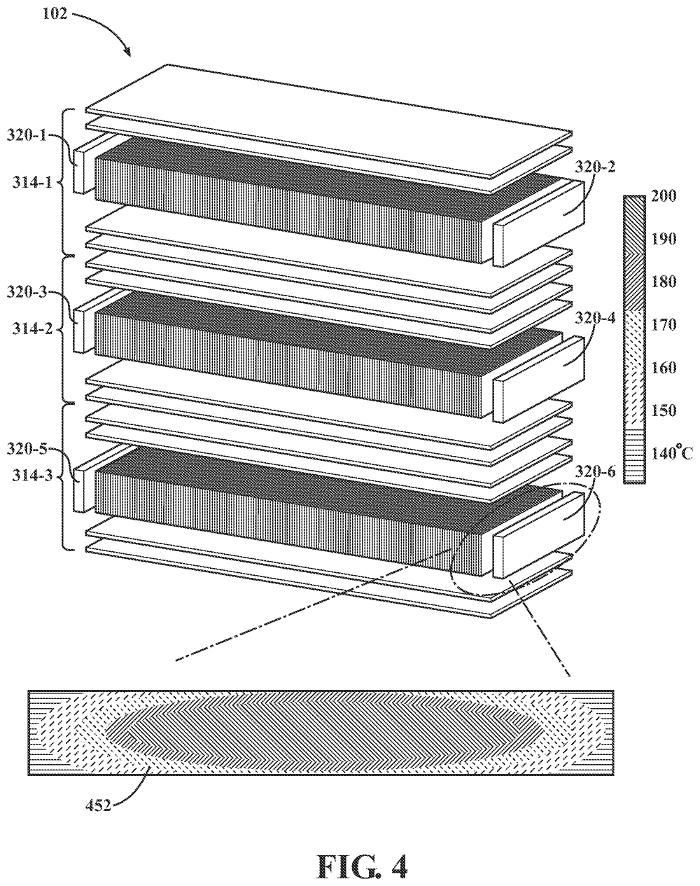

FIG. 4 is an exploded view of a fuel cell stack assembly 102 with interspersed insulation assemblies 342. That is, in an example, the fuel cell stack assembly 102 includes a set of fuel cell stacks 314-1, 314-2, and 314-3 adjacent to one another. As depicted in FIG. 4, the fuel cell stacks 314-1, 314-2, and 314-3 may be stacked on top of one another. Each fuel cell stack 314-1, 314-2, and 314-3 includes a set of fuel cells 318 and may be positioned between a pair of end plates 320 as described above. Specifically, a first fuel cell stack 314-1 is positioned between a first and second end plate 320-1 and 320-2. A second fuel cell stack 314-2 is positioned between a third and fourth end plate 320-3 and 320-4. A third fuel cell stack 314-3 is positioned between a fifth and sixth end plate 320-5 and 320-6. Note that while FIG. 4 depicts three fuel cell stacks 314-1, 314-2, and 314-3, any number of fuel cell stacks 314 may be adjacent to one another. Moreover, while FIG. 4 depicts vertically stacked fuel cell stacks 314, the fuel cell stacks 314 may be adjacent to one another in different arrangements, for example, side by side.

The fuel cell stack assembly 102 includes a pair of insulation assemblies 342 per fuel cell stack 314-1, 314-2, and 314-3. For example, given the fuel cell stack assembly 102 with three fuel cell stacks 314-1, 314-2, and 314-3 depicted in FIG. 4, there may be six insulation assemblies 342. For simplicity in FIG. 4, reference numbers for the the insulation assemblies 342 have been omitted. A bottom insulation assembly 342 of a first fuel cell stack 314-1 may be adjacent to a top insulation assembly 342 of a second fuel cell stack 314-2 as additionally depicted in FIG. 7. In these examples, the respective cooling plates 344 of the adjacent insulation assemblies 342 may be adjacent to one another and potentially joined together for example via an adhesive.

FIG. 4 also depicts a temperature profile 452 of the MEA 326 of one fuel cell 318 of the third fuel cell stack 314-3. As depicted, the majority of the third fuel cell stack 314-3 is kept within the desired operating temperature range for the fuel cell stack 314, which in this example may be between 160-200° C. This is because the cooling plates 344 prevent the increase of the fuel cell stacks 314 past a predetermined temperature.

The fuel cell stacks 314-1, 314-2, and 314-3 do not fall to the temperature of the coolant boiling point (e.g., 120° C.), which is outside of the target operating range on account of the insulating layer 350-1 and 350-2 that is positioned adjacent each cooling plate 344. Thus, the insulating layer 350-1 and 350-2 provides sufficient thermal conductivity to allow the cooling plates 344 to cool the fuel cell stacks 314-1, 314-2, and 314-3 to a certain degree, but not so much as to allow the fuel cell stacks 314-1, 314-2, and 314-3 to drop below a desired lower boundary of a target range.

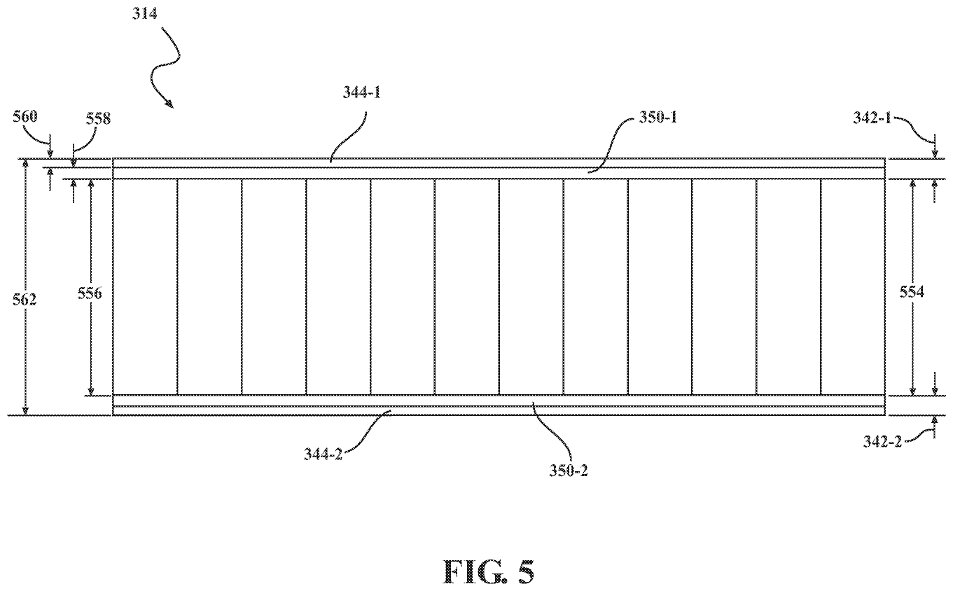

FIG. 5 is a cross-sectional view of a fuel cell stack 314 with an insulation assembly 342-1 and 342-2 joined to it. Note that within FIG. 5, the different elements are not drawn to scale. As described above, the fuel cell stack 314 includes a set 554 of fuel cells 318. In an example, the set 554 may have a reduced height 556. For example, the set 554 of fuel cells may have a height 556 of between three and five centimeters (cm). This reduced height 556, in addition to the interspersed insulation assemblies 342-1 and 342-2, provides a desired thermal gradient across the fuel cell stack 314 height. That is, were the fuel cell stack 314 taller, for example 15 centimeters, there may be more of a temperature gradient across the height of the fuel cell stack, with temperatures near the middle portion of the fuel cell stack 314 rising above the target temperature range for the fuel cell stack assembly 102. This may be because the cooling plate 344 cannot draw heat from the central portions of a tall fuel cell stack 314.

In another example, the set 554 of fuel cells may have a greater height. For example, the height 556 of the set 554 of fuel cells may be between 10-15 centimeters. In the example of the taller set 554 of fuel cells, the bipolar plates 336-1 and 336-2 may be formed of a material such as titanium, graphite, or coated aluminum with high thermal conductivity.

FIG. 5 also depicts the cooling plates 344-1 and 344-2 on either side of the set 554 of fuel cells 318. As described above, the cooling plates 344-1 and 344-2 may be formed of various thermally conductive materials such as aluminum. The cooling plates 344-1 and 344-2 also have a height 560. The cooling plates 344-1 and 344-2 may be between 10 and 15 millimeters (mm) thick, as indicated by the arrow 560. For example, the cooling plates 344-1 and 344-2 may be 13.5 mm thick. Cooling plates 344-1 and 344-2 of this thickness may provide space for internal coolant channels that traverse through the cooling plates 344-1 and 344-2.

As described above, the insulating layers 350-1 and 350-2 may be formed of any material that, at least partially, insulates the set 554 of fuel cells from the cooling plates 344-1 and 344-2. For example, the insulating layers 350-1 and 350-2 may be ceramic or aluminum-based thermally conductive epoxy. The insulating layers 350-1 and 350-2 also have a height 558. In an example, the insulating layers 350-1 and 350-2 have a thickness of between 1 and 3 mm. For example, the insulating layers 350-1 and 350-2 may be 1.5 mm thick. The thermal conductivity of the insulating layers 350-1 and 350-2 may be between 2 and 5 watts per meter kelvin (W/m·K). For example, the insulating layers 350-1 and 350-2 may have a thermal conductivity of 3 W/m·K. In an example, the overall height 562 of the fuel cell stack 314 may be between 3-8 cm.

FIG. 6 depicts a graph 664 of the temperature gradient across a height 562 of a fuel cell stack 314. The x-axis of the graph 664, going left to right, represents various vertical positions along a height 562 of the fuel cell stack 314, as depicted in FIG. 5, and the y-axis of the graph 664 represents the temperature at the respective vertical position. As depicted in FIG. 6, notwithstanding the temperature at the cooling plates 344-1 and 344-2 being 120° C., due to the inclusion of the insulating layers 350-1 and 350-2, the coldest portions of the fuel cells 314 are kept in the range of 160° C. Moreover, due to the cooling effect of the cooling plates 344-1 and 344-2, no portion of the fuel cell 318, and more particularly no portion of the MEA 326 of the fuel cell 318, rises above 200° C., which may be the upper limit of the target temperature range for the fuel cell stack assembly 102.

FIG. 7 is a cross-sectional view of a fuel cell stack assembly 102 with interspersed insulation assemblies 342. Specifically, FIG. 7 depicts an example of three fuel cell stacks 314-1, 314-2, and 314-3 stacked on top of one another. As described above, each fuel cell stack 314-1, 314-2, and 314-3 includes a pair of insulation assemblies 342. For example, a first fuel cell stack 314-1 may be positioned between a first insulation assembly (including a first cooling plate 344-1 and a first insulating layer 350-1) and a second insulation assembly (including a second cooling plate 344-2 and a second insulating layer 350-2). Similarly, a second fuel cell stack 314-2 may be positioned between a third insulation assembly (including a third cooling plate 344-3 and a third insulating layer 350-3) and a fourth insulation assembly (including a fourth cooling plate 344-4 and a fourth insulating layer 350-4). Still further, a third fuel cell stack 314-3 may be positioned between a fifth insulation assembly (including a fifth cooling plate 344-5 and a fifth insulating layer 350-5) and a sixth insulation assembly (including a sixth cooling plate 344-6 and a sixth insulating layer 350-6). In an example, insulation assemblies of adjacent fuel cell stacks 314 may contact one another and, in some cases, be joined via an adhesive. For example, a second insulation assembly (formed of the second cooling plate 344-2 and the second insulating layer 350-2) may be adjacent to the third insulation assembly (formed of the third cooling plate 344-3 and the third insulating layer 350-3). In this example, the adjacent cooling plates 344 may contact one another and be joined via an adhesive, for example.

FIG. 7 also depicts various components of the fuel cell 318, with the components of one fuel cell 318 being indicated by reference numbers. Specifically, FIG. 7 depicts the MEA 326, gas diffusion layers 334-1 and 334-2, bipolar plates 336-1 and 336-2, and the gasket 340 of one fuel cell 318.

As described above, each fuel cell stack 314 may have a reduced height such that the coolant has a greater effect across the height of the respective fuel cell stacks 314. That is, were the individual fuel cell stacks 314 taller, the cooling effect of the coolant may not reach a middle portion of the respective MEAs 326, thus resulting in a greater temperature in the center of the MEA 326, which temperature may be greater than an upper boundary of the target temperature range (e.g., 200° C.).

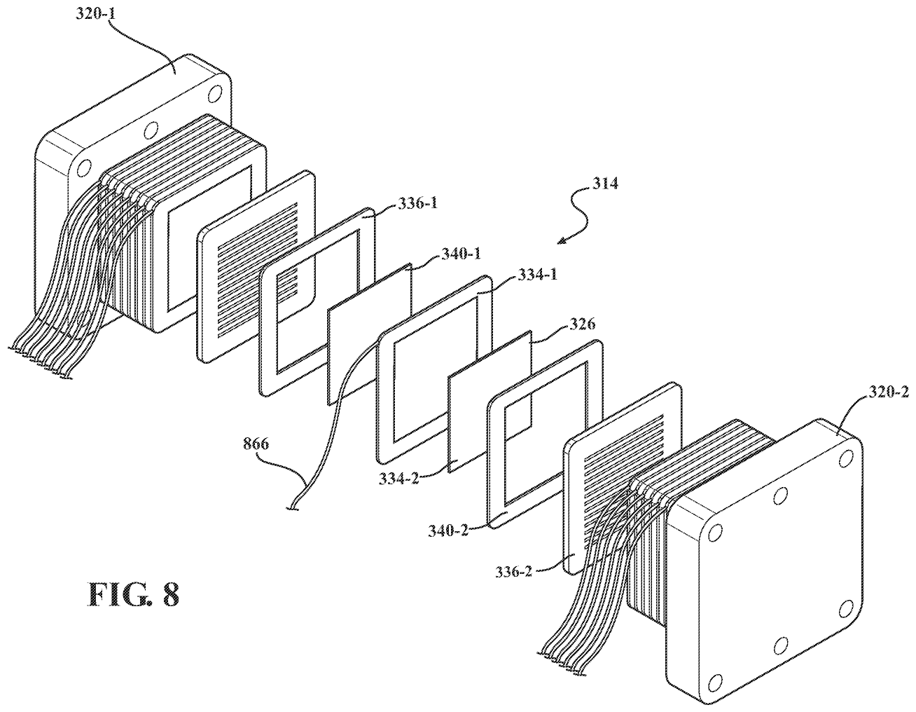

FIG. 8 is an exploded view of a per-cell electrically connected fuel cell stack 314. In this example, rather than having a current collector 338-1 and 338-2 that combines the electricity generated by each fuel cell 318 as depicted in FIG. 3A, the electrical system includes cell-specific electrical connections 866 per fuel cell 318. For simplicity, FIG. 8 depicts a single electrical connection 866. However, each fuel cell 318 may include similar electrical connections 866. Electricity generated by each MEA 326 is transmitted to the electric component to be powered, e.g., the truck 100 electric motor, via respective electrical connections 866.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A fuel cell stack, comprising:
a set of fuel cells positioned between a pair of end plates; and
a pair of insulation assemblies positioned along opposite side surfaces of the set of fuel cells and spanning a length of the set of fuel cells between the pair of end plates, an insulation assembly comprising:
a cooling plate extending across the set of fuel cells; and
an insulating layer between the cooling plate and the set of fuel cells.

2. The fuel cell stack of claim 1, wherein the set of fuel cells comprises high-temperature fuel cells having an operating temperature range of between 160 and 200 degrees Celsius.

3. The fuel cell stack of claim 1, wherein the insulating layer is an insulating adhesive joining the cooling plate to the set of fuel cells.

4. The fuel cell stack of claim 1, wherein the cooling plate further comprises a coolant inlet and a coolant outlet in fluid communication via an internal coolant channel of the cooling plate.

5. The fuel cell stack of claim 1, wherein:
the cooling plate has a thickness of between 10 and 15 millimeters (mm);
the insulating layer has a thickness of between 1 and 3 mm; and
the insulating layer has a thermal conductivity of between 2 and 5 watts per meter kelvin (W/m·K).

6. The fuel cell stack of claim 1, wherein the set of fuel cells has a height of between 3 and 5 centimeters (cm).

7. The fuel cell stack of claim 1, further comprising at least one of:
a pair of current collectors positioned adjacent to opposite end surfaces of the set of fuel cells, each current collector is positioned between the set of fuel cells and a respective end plate; or
a cell-specific electrical connection connected to each fuel cell.

8. The fuel cell stack of claim 1, wherein:
the cooling plate is a single-phase cooling plate; and
the cooling plate transports a water and ethylene glycol-based coolant.

9. A fuel cell stack assembly, comprising:
a set of fuel cell stacks adjacent to one another, a fuel cell stack comprising a set of fuel cells positioned between a pair of end plates; and
a pair of insulation assemblies per fuel cell stack, the insulation assemblies are positioned along opposite side surfaces of a respective set of fuel cells of a fuel cell stack and span a length of the respective set of fuel cells between the pair of end plates, an insulation assembly comprising:
a cooling plate extending across the respective set of fuel cells; and
an insulating layer between the cooling plate and the respective set of fuel cells.

10. The fuel cell stack assembly of claim 9, wherein the set of fuel cell stacks generates between 200 and 500 kilowatts (kW) of power.

11. The fuel cell stack assembly of claim 9, wherein the set of fuel cell stacks comprise high-temperature fuel cells having an operating temperature of between 160 and 200 degrees Celsius.

12. The fuel cell stack assembly of claim 9, wherein the insulating layer is an insulating adhesive joining the cooling plate to a respective set of fuel cells.

13. The fuel cell stack assembly of claim 9, wherein the cooling plate further comprises a coolant inlet and a coolant outlet in fluid communication via an internal coolant channel of the cooling plate.

14. The fuel cell stack assembly of claim 9, wherein:
the cooling plate has a thickness of between 10 and 15 millimeters (mm);
the insulating layer has a thickness of between 1 and 3 mm; and
the insulating layer has a thermal conductivity of between 2 and 5 watts per meter kelvin (W/m·K).

15. A fuel cell stack assembly, comprising:
a set of high-temperature proton exchange membrane (PEM) fuel cell stacks adjacent to one another, a PEM fuel cell stack comprising a set of fuel cells positioned between a pair of end plates; and
a pair of insulation assemblies per PEM fuel cell stack, the insulation assemblies are positioned along opposite side surfaces of a respective set of fuel cells of a PEM fuel cell stack and span a length of the respective set of fuel cells between the pair of end plates, an insulation assembly comprising:
a cooling plate extending across the respective set of fuel cells; and
an insulating layer between the cooling plate and the respective set of fuel cells.

16. The fuel cell stack assembly of claim 15, wherein the set of high-temperature PEM fuel cell stacks generate between 200 and 500 kilowatts (kW) of power.

17. The fuel cell stack assembly of claim 15, wherein the insulating layer is an insulating adhesive joining the cooling plate to the respective set of fuel cells.

18. The fuel cell stack assembly of claim 15, wherein the cooling plate further comprises a coolant inlet and a coolant outlet in communication via an internal coolant channel of the cooling plate.

19. The fuel cell stack assembly of claim 15, wherein:
the cooling plate has a thickness of between 10 and 15 millimeters (mm);
the insulating layer has a thickness of between 1 and 3 mm; and
the insulating layer has a thermal conductivity of between 2 and 5 watts per meter kelvin (W/m·K).

20. The fuel cell stack assembly of claim 15, wherein each high-temperature PEM fuel cell has a height of between 3 and 5 centimeters (cm).
